(19) United States
(12) Patent Application Publication
(10) Pub. No.: US 2004/0137895 A1
(43) Pub. Date: Jul. 15, 2004

(54) Remote monitoring system

(76) Inventor: David Hyman Gordon, Newton Mearns Glasgow (GB)

Correspondence Address: OLSON & HIERL, LTD., 20 NORTH WACKER DRIVE, 36TH FLOOR, CHICAGO, IL, 60606, US

(21) Appl. No.: 10/474,097

(22) PCT Filed: Mar. 9, 2001
(86) PCT No.: PCT/GB01/01017

(51) Int. Cl. H04M 3/00

(52) U.S. Cl. 455/420

(57) ABSTRACT

A remote monitoring system comprising a signal emitter providing a signal, means for detecting the signal, means for transmitting the signal via a telecommunications system and remote means for receiving the transmitted signal.

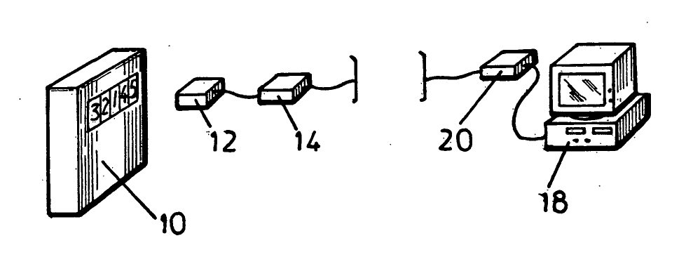

### FIELD OF THE INVENTION

This invention concerns monitoring systems, particularly but not exclusively for use by utility services.

### BACKGROUND OF THE INVENTION

Utility meters, such as for water, gas and electricity supplies have to be read directly periodically in order to assess charges. However, if access to a meter is not possible when the meter reader calls, an estimated charge is made, which can lead to incorrect charging, if the meter is not read for some time. It would, therefore, be advantageous to read such meters remotely.

An object of this invention is to provide an improved remote monitoring system, which may be used for remote monitoring of utility service meters.

### SUMMARY OF THE INVENTION

According to this invention there is provided a remote monitoring system comprising a signal emitter providing a signal, means for detecting the signal, means for transmitting the signal via a telecommunications system and remote means for receiving the transmitted signal.

The signal may be transmitted in any desired format, such as data or an image in digital form.

As well as transmitting signals, the system of the invention may further comprise means for receiving a signal from a remote source for activating the system.

Signal transmission to and from the remote monitoring system of the invention is preferably via a fixed telecommunications transmission line.

The monitoring system of the invention may be used to read utility meters, wherein the signal emitter is a utility meter, such as an electricity supply meter, a gas supply meter or a water supply meter. For convenience, the meter dial can be viewed by a camera and the reading transmitted via a telephone line.

The monitoring system of the invention preferably further comprises at a remote location a modem for receiving the transmitted signal and a computer programmed to store the signal received and optionally to instigate a response thereto.

The computer is preferably programmed to interrogate the signal emitter remotely, randomly or at predetermined intervals.

The signal transmitting means preferably has battery power back-up. Operation of the battery power back-up preferably activates a signal transmission to the transmitted signal receiving means. Preferably, the monitoring system of the invention has means for sending a message to a designated receiver upon receipt of said battery power back-up signal. The designated receiver may be a telephone and the message may be a pre-recorded voice message.

In a preferred embodiment of the invention, a utility meter with a display giving a reading as a numerical value has a camera arranged to capture the image of the display, preferably enclosed in a sealed box to avoid tampering. The camera may be a video camera and image recognition software may be used for determining the numerical display for entry into an appropriate account record. Alternatively, a digital camera may be used to record the numerical display digitally and the digital data used to enter the appropriate numerical value displayed in the appropriate account record.

Data transfer from the camera to a central computer is preferably via a telephone dialler connected to a fixed telephone line. The system of the invention may be programmed for timed meter reading and/or for on demand meter reading.

This invention will now be further described, by way of example only, with reference to the accompanying drawing, which shows schematically a utility meter reading system according to the invention.

### BRIEF DESCRIPTION OF THE DRAWINGS

Referring to the accompanying drawing, a utility meter 10 has a numerical display 12 and a camera 14 arranged to capture the numerical display as an image in a form suitable for transmission down a telephone line. The camera is connected to a telephone dialler and the captured image can be transmitted down the telephone line 16 to a computer 18 via a modem 20. The computer is programmed to connect the numerical display image into a format that can be entered into the appropriate account record.

### DETAILED DESCRIPTION

The output from the camera provides a signal corresponding to the numerical value of the utility meter enabling that value to be recorded against the account relative to that meter.

The system can be arranged for either or both of timer controlled operation from the meter end of the system and the central computer end of the system. In that way, the reading of the utility meter can be independent of the owner of the premises where the meter is situated and independent of visiting meter readers. The need for estimated billings for utilities can, therefore, be eliminated. Accurate billing for utilities is an advantage to both provider and consumer.

The provision of remote meter reading enables the utility supplier to instantly read any meter on demand. The meter reading can be performed in two ways, namely by image capture or by extracting the information from the IR port on the meter front panel. This could be taken a stage further by providing the utility supplier with the facility of either shutting down or altering the tariff of the supply which often requires a site visit from an engineer to alter via the IR port.

All standard status transfers, including sending remote control information to the domestic base, will use the telephone line with any image information meter reading being sent by data format.

What is claimed is:

1. A remote monitoring system comprising a signal emitter providing a signal, means for detecting the signal, means for transmitting the signal via a telecommunications system and remote means for receiving the transmitted signal.

2. A system as claimed in claim 1, wherein the signal is transmitted as data.

3. A system as claimed in claim 1, wherein the signal is transmitted as an image in digital form.

4. A system as claimed in claim 1, further comprising means for receiving a signal from a remote source for activating the system.

5. A system as claimed in claim 1, wherein signal transmission to and from the system is via a fixed telecommunications transmission line.

6. A system as claimed in claim 1, wherein the signal emitter is a utility meter.

7. A system as claimed in claim 6, wherein the utility meter has a dial providing the signal and means for detecting the signal is a camera.

8. A system as claimed in claim 1, further comprising, at a remote location, a modem for receiving the transmitted signal and a computer programmed to store the signal received and optionally to initiate a response thereto.

9. A system as claimed in claim 8, wherein the computer is programmed to interrogate the signal emitter remotely, randomly or at predetermined intervals.

10. A system as claimed in claim 1, wherein the signal transmitting means has battery power back-up.

11. A system as claimed in claim 10, wherein operation of the battery power back-up activates a signal transmission to the transmitted signal receiving means.

12. A system as claimed in claim 11 further having means for sending a message to a designated receiver upon receipt of said battery power back-up signal.

13. A system as claimed in claim 12, wherein the designated receiver is a telephone.

14. A system as claimed in claim 13, wherein the message is a pre-recorded voice message.

15. A system as claimed in claim 1, comprising a utility meter with a display giving a reading as a numerical value and a camera arranged to capture the image of the display.

16. A system as claimed in claim 15, wherein the utility meter and camera are enclosed in a sealed box.

17. A system as claimed in claim 15, wherein the camera is a video camera and image recognition software is used for determining the numerical display for entry into an account record.

18. A system as claimed in claim 15, wherein the camera is a digital camera for recording the numerical display digitally and the digital data is used to enter the numerical value in an amount record.

19. A system as claimed in claim 8, wherein data transfer from the camera to the computer is via a telephone dialler connected to a fixed telephone line.

20. A system as claimed in claim 15, programmed for timed meter reading and/or on demand meter reading.

21. A remote monitoring system substantially as hereinbefore described with reference to and as illustrated in the accompanying drawing.
